(19) United States
(12) Patent Application Publication
(10) Pub. No.: US 2021/0056641 A1
(43) Pub. Date: Feb. 25, 2021

(54) Computer System Architecture for Integrated Coverage Platform for Implementing an Adaptive Coverage Policy

(71) Applicant: DealerPolicy, Inc., Williston, VT (US)

(72) Inventors: Travis M. Fitzgerald, Colchester, VT (US); Jeffrey Mongeon, Colchester, VT (US); Michael John Burgiss, Marietta, GA (US); Weili Yuh, Needham, MA (US); Ryan Fitzgerald, Williston, VT (US); Xiaochen Xing, Boston, MA (US)

(21) Appl. No.: 17/089,925

(22) Filed: Nov. 5, 2020

Related U.S. Application Data
(63) Continuation-in-part of application No. 16/574,623, filed on Sep. 18, 2019.
Application No. 16/574,623 is a continuation-in-part of application No. 15/142,387, filed on Apr. 29, 2016, now Pat. No. 10,650,462.
(60) Provisional application No. 62/932,880, filed on Nov. 8, 2019.
(60) Provisional application No. 62/155,914, filed on May 1, 2015.
(60) Provisional application No. 62/734,467, filed on Sep. 21, 2018.
(60) Provisional application No. 62/795,754, filed on Jan. 23, 2019.
(60) Provisional application No. 62/822,681, filed on Mar. 22, 2019.

(51) Int. Cl. G06Q 40/08; G06F 16/9535; G06F 16/9538; G06Q 10/10; G06Q 30/00; G06N 20/00; G06T 7/00

(52) U.S. Cl. CPC G06Q 40/08; G06F 16/9535; G06F 16/9538; G06T 7/0002; G06Q 30/012; G06N 20/00; G06Q 10/10

(57) ABSTRACT

A connectivity hub server detects the occurrence of a qualifying update event associated with a user and generates one or more recommended updates to the user's existing coverage based on the qualifying update event. Responsive to the user electing an adaptive coverage policy during an initial coverage binding process, the connectivity hub server periodically queries one or more third-party data sources for information associated with the user and analyzes the received information to detect the occurrence of a qualifying update event. Modules of the connectivity hub server determine one or more recommended coverage updates based on a stored mapping and implement one or more of the recommended coverage updates based on instructions from the user device.

### CROSS-REFERENCE TO RELATED APPLICATIONS

This application claims the benefit of U.S. Provisional Application No. 62/932,880, filed Nov. 8, 2019, which is incorporated by reference in its entirety.

This application is also a continuation-in-part of co-pending U.S. application Ser. No. 16/574,623 (the '623 application), filed Sep. 18, 2019, which is a continuation-in-part of U.S. application Ser. No. 15/142,387, filed Apr. 29, 2016 (now U.S. Pat. No. 10,650,462), which claims priority to U.S. Provisional Application No. 62/155,914, filed May 1, 2015. The '623 application also claims priority to U.S. Provisional Application No. 62/734,467, filed Sep. 21, 2018, U.S. Provisional Application No. 62/795,754, filed Jan. 23, 2019, and U.S. Provisional Application No. 62/822,681, filed Mar. 22, 2019. All of these applications are incorporated by reference in their entirety.

### BACKGROUND

### 1. Technical Field

The subject matter described generally relates to a coverage selection system, and in particular, to a system architecture including a connectivity hub with adaptive coverage features.

### 2. Background Information

Current computing systems used in providing coverage protection (e.g., insurance protection for goods and services) are configured so that a user seeking to bind multiple types of coverage must complete and submit multiple applications through separate processes. Each application requires large amounts of personal data about the user and requires the user to manually enter the data and/or the computing system to query third-party data sources to obtain the needed information, creating inefficiencies and increasing the likelihood of erroneous data entry. Additionally, a user's coverage needs are likely to change over time. For example, if the user whose current coverage includes a rental policy purchases a condo or single-family home, the initial coverage by which the user is bound may no longer fit the user's needs. However, current systems require the user to cancel their existing coverage and bind new coverage in a separate application process, leading to computational inefficiencies. Still further, the user may not understand how the purchase of a home or other life event impacts the user's coverage needs and may need to invest significant amounts of time in researching and/or speaking with a coverage provider about dozens of coverage options and endorsements that might not fit the user's needs, creating further inefficiencies in the coverage binding process.

### SUMMARY

A connectivity hub server facilitates connections and interactions between processors associated with multiple entities participating in the purchase and sale of goods and related coverage services. In one embodiment, a customer user seeking coverage interacts, through a user client device or a dealer terminal, with a connectivity hub server and a coverage provider processor of a selected coverage provider to bind coverage for a selected coverage option. During the binding process, the user elects an adaptive coverage policy and consents to the connectivity hub server periodically querying third-party data sources to obtain information about qualifying update events associated with the user, such as the user's purchase of a home, the birth of a child, or the purchase of personal property valued at over a specified amount (e.g., a boat, a snowmobile, an RV, and the like). In other embodiments, the connectivity hub server is notified of the event through user input through the user client device. Responsive to detecting the occurrence or receiving a notification of the qualifying update event, the connectivity hub server queries a stored mapping to determine one or more proposed coverage updates to display to the user. For each qualifying update event, the mapping includes one or more recommended updates to a user's existing policy that add, remove, or change coverage. For instance, with respect to the examples discussed above, the mapping might indicate that the purchase of a boat is associated with a recommendation (e.g., via endorsement or rider) to add boat insurance (e.g., including one or more of liability, uninsured motorist, and collision/comprehensive coverage) or that the birth of a child is associated with a recommendation to add term life coverage to the user's existing policy. In one embodiment, where the qualifying update event is the purchase or other acquisition of real or personal property, the connectivity hub server instructs the user to submit one or more photos of the property and applies a risk algorithm to determine whether to provide the recommended coverage updates.

If the output of the risk algorithm indicates that the risk of providing coverage for the property is below a threshold level, the connectivity hub server provides the one or more recommended updates for display to the user through the user client device. Responsive to receiving user input comprising an instruction to implement one or more of the recommended updates, the connectivity hub server updates the existing coverage in accordance with the user input and, in some embodiments, notifies a coverage provider processor of the coverage update.

### BRIEF DESCRIPTION OF THE DRAWINGS

FIG. 1 is a block diagram illustrating a networked computing environment, according to one embodiment.

FIG. 2 is a block diagram illustrating subsystems of a connectivity hub server, according to one embodiment.

FIG. 3 is a data flow illustrating a method for binding an adaptive coverage policy, according to an embodiment.

FIG. 4 is flow chart illustrating a method for implementing an adaptive coverage policy, according to an embodiment.

FIG. 5 is a subsystem diagram illustrating components of the connectivity hub server 105 and interactions between the components, according to one embodiment.

FIG. 6 is a block diagram illustrating an example of a computer suitable for use in the networked computing environment of FIG. 1, according to one embodiment.

### DETAILED DESCRIPTION

The Figures (FIGS.) and the following description describe certain embodiments by way of illustration only. One skilled in the art will readily recognize from the following description that alternative embodiments of the structures and methods may be employed without departing from the principles described. Reference will now be made to several embodiments, examples of which are illustrated in the accompanying figures. It is noted that wherever practicable similar or like reference numbers are used in the figures to indicate similar or like functionality.

### Example Networked Computing Environment

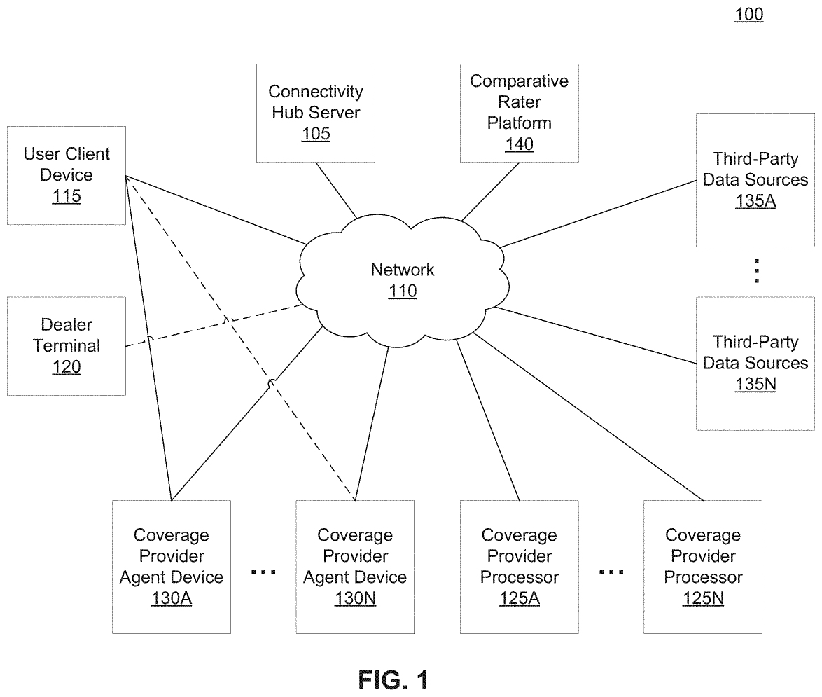

FIG. 1 illustrates one embodiment of a networked computing environment 100 that facilitates connections between processors associated with client devices, coverage providers, dealers, and third-party data sources to adapt coverage services based on the occurrence of qualifying update events. In the embodiment shown in FIG. 1, the networked computing environment 100 includes a connectivity hub server 105 in communication through a network 110 with a user client device 115, a dealer terminal 120, one or more coverage provider processors 125A-N, one or more coverage provider agent devices 130A-N, one or more third party data sources 135A-N, and a comparative rater platform 140. In other embodiments, the networked computing environment 100 contains different and/or additional elements. In addition, the functions may be distributed among the elements in a different manner than described.

FIG. 1 uses like reference numerals to identify like elements. A letter after a reference numeral, such as “130A,” indicates that the text refers specifically to the element having that particular reference numeral. A reference numeral in the text without a following letter, such as “130,” refers to any or all of the elements in the figures bearing that reference numeral. For example, “130” in the text references to the reference numerals “130A” and “130N” in the figures.

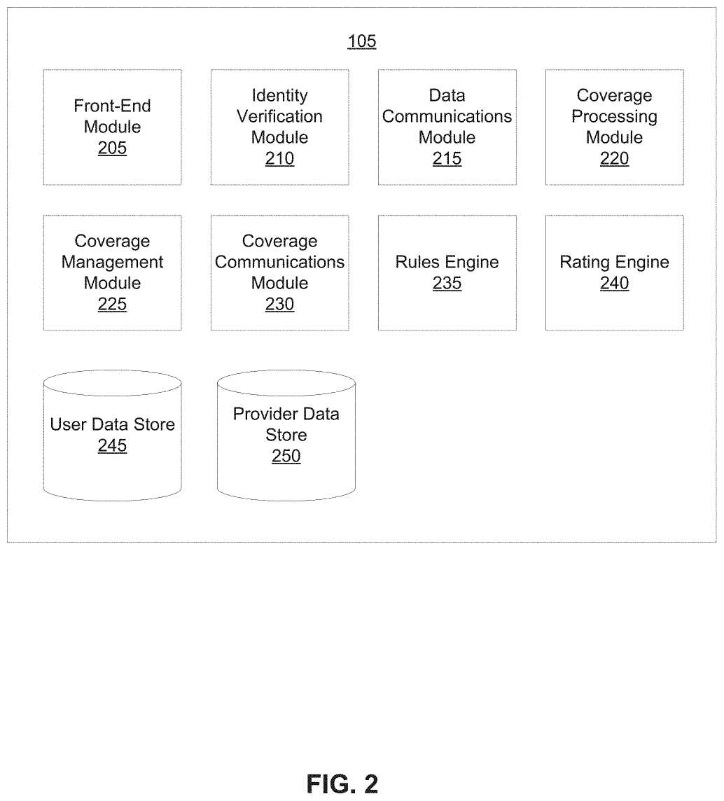

The connectivity hub server 105 provides a platform that allows customer, dealer, and coverage provider users to interact to bind and update coverage between the customer user (referred to as a “user” herein) and a selected provider based on the occurrence of a qualifying update event. In various embodiments, the modules of the connectivity hub server 105 enable these interactions by analyzing user data received from the third-party data sources 135 to detect occurrence of a qualifying update event, querying the user client device 115 to confirm the occurrence of the event, receiving user input to update existing coverage based on the occurrence of the event, and instructing a coverage provider processor 125A to update existing coverage for the user. Various embodiments of the connectivity hub server 105 are described in greater detail below, with reference to FIG. 2.

The network 110 comprises any combination of local area and/or wide area networks, using both wired and/or wireless communication systems. In one embodiment, the network 110 uses standard communications technologies and/or protocols. For example, the network 110 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 110 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 110 may be represented using any suitable format, such as hypertext markup language (HTML) or extensible markup language (XML). Those skilled in the art will recognize that encryption using other suitable techniques will be appropriate for various applications based on the nature of the network 110.

The user client device 115, the dealer terminal 120, and the one or more coverage provider agent devices 130 are computing devices capable of receiving user input as well as transmitting and/or receiving data via the network 110. In one embodiment, the devices 115 and 130 and the terminal 120 are conventional computer systems, such as a desktop or laptop computer. Alternatively, the devices 115 and 130 and the terminal 120 are devices having computer functionality, such as a mobile telephone, a smartphone, a set-top box, a smart home device, or another suitable device. The devices 115 and 120 and the terminal 120 further include an input/output (I/O) component to transfer data to, and receive data from, other entities in the networked computing environment 100, and a storage unit to store, for example, coverage documents for a selected policy.

In various embodiments, the devices 115 and 130 and the terminal 120 connect through the network 110 to the connectivity hub server 105 and/or directly (e.g., using a peer-to-peer protocol) to one or more other devices 115 and 130 or the terminal 120 in the networked computing environment 100. For example, in one embodiment, the user client device 115 connects through the network 110 to the connectivity hub server 105 to input user data and obtain information regarding available coverage options (e.g., through an application associated with the connectivity hub server 105 or through a web browser on the user client device 115). Alternatively, the user interacts with the connectivity hub server 105 through the dealer terminal 120.

Each coverage provider processor 125 is associated with one or more coverage provider agent devices 130 through which users interact with a selected coverage provider to bind coverage or to update existing coverage based on the occurrence of one or more qualifying update events. The coverage provider processor 125 receives requests from the user through the user client device 115 or the dealer terminal 120 for policy coverage options and generates rates based on user data received through the connectivity hub server 105. Responsive to the user selecting an available coverage option, the coverage provider processor 125A of the selected provider establishes a direct connection with the user client device 115 or the dealer terminal 120 (e.g., to bind and purchase coverage or to update existing coverage, as discussed below with respect to FIG. 2).

The environment 100 of FIG. 1 also includes one or more third-party data sources 135A-N that store user data used by the connectivity hub server 105 to facilitate generating, selecting, and updating coverage options. In one embodiment, the third-party data sources 135 include one or more coverage providers, such as the coverage providers associated with the coverage provider processors 125. Other third-party data sources 135 include financial institutions, mortgage providers, data analytics and risk assessment entities, credit bureaus, and public databases from which the connectivity hub server 105 obtains data that the user has consented to sharing for purposes of the coverage binding and updating process. Data received from the third-party data sources 135 is used, for example, to prefill user applications for insurance coverage, thus improving the efficiency and accuracy of the coverage selection process by reducing the amount of user data entered manually by the user or dealer. Received user data is further used, in some embodiments, by the connectivity hub server 105 to verify the accuracy of user data manually input through the user client device 115. Still further, the modules of the connectivity hub server 105 analyze user data from the third-party data sources 135 to determine whether one or more qualifying update events has occurred and query the user through the user client device 115 to confirm the occurrence of the event and to determine whether an existing coverage policy should be updated accordingly.

In various embodiments, user data provided by the third-party data sources 135 to the connectivity hub server 105 includes personally identifiable information (PII) about the user. User data further includes, in various implementations, demographic data, vehicle driving record violations and incidents, vehicles/equipment currently in possession of the user and related liens and leases, current insurance coverage types and amounts and associated carrier(s), insurance claim history for a user, the user's household members and real and personal property. As discussed below with respect to FIG. 2, the modules of the connectivity hub server 105 analyze the user data to determine the occurrence of one or more qualifying update events, such as a financial event (e.g., the purchase of a condominium or single-family home, the purchase or other acquisition of personal property valued at over a specified amount (e.g., a boat, a snowmobile, an RV, an engagement ring, etc.), or a life event (e.g., a wedding, divorce, birth of a child, etc.).

The comparative rater platform 140 generates available coverage options and rates for a requesting user based on received user data. In one embodiment, the comparative rater platform 140 uses direct API access to one or more coverage provider processors 125 to obtain and aggregate coverage option and rate data. The aggregated data is stored and used to generate coverage options for a user without requiring the modules of the connectivity hub server 105 to query the coverage provider processors 125 directly. The connectivity hub server 105 thus queries the comparative rater platform 140 with a completed coverage application for a requesting user, and the comparative rater platform 140 returns initial coverage options and rates based on the stored coverage provider data and the received coverage application. In some embodiments, the connectivity hub server 105 performs risk filtering before sending the user application to the comparative rater platform. For example, in some implementations, the connectivity hub server 105 uses machine learning to predict, for new users, which coverage provider the user might select, how long the user might remain with the selected coverage provider, etc. Additionally, while the displayed embodiment shows the comparative rater platform 140 as a third-party platform connected through the network 110 to the connectivity hub server 105, in other embodiments, the comparative rater platform is a module on the connectivity hub server 105.

### Example Connectivity Hub Server Subsystems

FIG. 2 is a block diagram of an architecture of the connectivity hub server 105. The connectivity hub server 105 shown in FIG. 2 includes a front-end module 205, an identity verification module 210, a data communications module 215, a coverage processing module 220, a coverage management module 225, a coverage communications module 230, a rules engine 235, a rating engine 240, a user data store 245, and a provider data store 250. In other embodiments, the connectivity hub server 105 includes additional, fewer, or different components for various applications. Conventional components such as network interfaces, security functions, load balancers, failover servers, management and network operations consoles, and the like are not shown so as not to obscure the details of the system architecture.

The front-end module 205 facilitates communication between the connectivity hub server 105 and the user client device 115, the dealer terminal 120, the coverage provider processors 125, and the third-party data sources 135. In one embodiment, the third-party data sources 135 interact with the connectivity hub server 105 through the front-end module 205 to provide requested user data. Coverage provider processors 125 also interact with the connectivity hub server 105 through the front-end module 205 to provide new or updated coverage options based on the received user data. Similarly, the user client device 115 submits requests for coverage options and inputs user data to the connectivity hub server 105 through the front-end module 205. For example, in one embodiment, user data input through the front-end module 205 includes basic user information, such as the user's name, address, date of birth, driver's license number, phone number, email address, marital status, residence type, gender; other pertinent information, such as information concerning a vehicle or other good being purchased, accidents, violations, or losses associated with the user during a specified time period; information about the user's current coverage, such as the user's current insurance company(ies), premium(s), whether the user is eligible for policy discounts; and related permissions, including permission for the connectivity hub server 105 to query one or more third-party data sources 135 to obtain additional data about the user, such as the user's current insurance score. In other embodiments, the front-end module 205 prompts the user to enter minimal PII, such as the user's phone number, the zip code of the user's primary residence, and/or the user's date of birth. The front-end module 205 transmits the received user data to the identity verification module 210, which verifies the user's identity, as discussed below.

In some embodiments, the front-end module 205 further uses machine learning to determine which third-party data source(s) 135 to query to obtain additional data about the user. For example, the amount and type of data stored by each of the third-party data sources 135 for users of the connectivity hub server 105 may vary based on, e.g., whether the user is a user of the third-party data source 135 or whether the type of data stored by the third-party data source 135 is relevant to the request for coverage. In some embodiments, input to a machine learning model includes one or more items of user profile data, including the user's likelihood of purchasing coverage, how many vehicles and drivers are in the user's household, an expected closing ratio, and the like. The model outputs an indication of one or more third-party data sources 135 to query for additional user data.

The front-end module 205 further queries the user client device 115 to obtain user consent to sharing the collected user data with one or more third-party data sources 135 and one or more coverage provider processors 125. For example, in one embodiment, the connectivity hub server 105 transmits minimal PII about the user to one or more third-party data sources 135 to obtain additional information about the user that may be used, for instance, to prefill a user application for insurance coverage. In another example, user data obtained from user input (via the user client device 115 or the dealer terminal 120) and/or from third-party data sources 135 is transmitted to one or more coverage provider processors 125, of which a subset of the coverage provider processors 125 return available coverage options based on the transmitted user data. Responsive to the connectivity hub server 105 receiving the available coverage options, the front-end module 205 provides the coverage options for display on the user client device 115.

In embodiments in which a user's existing coverage is updated based on the occurrence of a qualifying update event, the front-end module 205 queries the user through the user client device 115 to confirm the occurrence of the event and to determine whether the user wants to update existing coverage based on the occurrence of the event. For example, responsive to the modules of the connectivity hub server 105 detecting, using data received from a third-party data source 135, that a user whose existing coverage includes renter's insurance (with renter rates for personal property coverage) is purchasing a condominium or single-family home, the front-end module 205 queries the user client device 115 to confirm the user's purchase and to ask the user whether they want to endorse the existing policy to update the user's address, add dwelling, outbuilding, personal liability with a higher limit, medical payments, and other optional coverages typically associated with condominiums and single-family homes without starting a new policy. In another example, responsive to the modules of the connectivity hub server 105 determining that the user or their partner has given birth to a child, the front-end module 205 queries the user with a suggestion that the user endorse the user's existing policy with term life coverage. Alternatively, detection of a qualifying update event is based on user input through the user client device 115 (e.g., via an application associated with the connectivity hub server 105 or through a native web browser on the user client device 115). For instance, in one example, the user provides input indicating that the user purchased an engagement ring or other valuable item of personal property, and the front-end module 205 queries the user client device 115 to suggest that the user increase existing personal property coverage. In either embodiment, responsive to receiving input from the user client device 115 instructing the connectivity hub server 105 to update the existing coverage, the front-end module 205 notifies the coverage management module 225 of the update instruction, as discussed below.

In some embodiments, in response to detecting the occurrence of a qualifying update event or receiving user input notifying the connectivity hub server 105 of the event occurrence, the front-end module 205 queries the user (e.g., through an application associated with the connectivity hub server 105) to submit one or more photos associated with the event, e.g. using a camera on the user client device 115. For example, if the qualifying update event is the purchase of a boat, the front-end module 205 instructs the user client device 115 to initiate the camera to allow the user to take one or more photos of the boat (e.g., from different angles). The front-end module 205 similarly prompts the user to provide one or more photos through the application on the user client device 115 if the qualifying update event is associated with the purchase or renovation of real property. Responsive to receiving the one or more photos, the front-end module 205 sends the photos to the rules engine 235 to determine whether the user's existing coverage may be updated based on the event occurrence. In this way, the user is able to avoid physical inspections typically required to bind or update coverage. The front-end module 205 subsequently transfers the photos to the coverage provider agent device 130A associated with the selected coverage provider processor 125A for a human agent to process. In embodiments in which a direct communication is established between the user client device 115 and the selected coverage provider processor 125A, the user client device 115 sends the photos with the application through the front-end module 205 to the selected coverage provider directly to bind or update coverage.

In embodiments in which the user is seeking to bind coverage, the identity verification module 210 verifies the user's identity based on the user data received through the user client device 115. For example, in one embodiment, a user of the dealer terminal 120 inputs a phone number of a user through the front-end module 205. Responsive to receiving the phone number, the identity verification module 210 sends a message (e.g., via SMS, text, email, or the like) to the user client device 115 associated with the phone number. Selection of an address (e.g., HTTP, URL, or other network address) in the message connects the user client device 115 to the front-end module 205, which prompts the user to enter one or more items of PII, such as the user's zip code of primary residence and date of birth. The identity verification module 210 compares the received PII with data received from one or more third-party data sources 135 that store information, including unique identifying information, describing the ownership and use relationships between users and associated devices and verifies the user identity based on the compared data (i.e., based on the received PII matching the client device 115 from which the PII was sent). For example, in one embodiment, the identity verification module 210 combines the PII with one or more unique network interface device address/identification numbers (e.g., a SIM card, EMIEA number, or the like) to locate a subscriber record in a consumer information database connected to the connectivity hub server 105 and appends the subscriber data record to the PII received from the user client device 115.

The data communications module 215 interfaces with the third-party data sources 135 to obtain additional data about the user. Third-party data sources 135 typically provide data in various formats that are not all consistent with any particular standard or with one another. Data communications module 215 accordingly provides, for each of such data sources 135, a mechanism for properly communicating with such source.

In one embodiment, the data communications module 215 uses a carrier onboarding tool (not shown) with a rules engine to determine the coverage provider processors 125 to which to send user data. User data is gathered from a variety of sources, including via data entry through the user client device 115 or the dealer terminal 120 and one or more third-party data sources 135 who provide marketing data, public data, court-based records, and other user data that the user has consented to sharing for purposes of the coverage binding or updating process. Based on user data such as household composition, driver class, driving history, and insurance status, the carrier onboarding tool interacts with a machine learning trained predictive model to predict the most appropriate coverage provider(s) for receiving the user data.

The carrier onboarding tool (COT) is a system that integrates with multiple rating provider systems (not shown), including a rating engine 240), to obtain, aggregate, reconcile, and standardize coverage rating configuration data and to rate risks for a plurality of carriers (e.g., every risk for every carrier in every state). The system allows a user to reconcile coverage provider, carrier, and state-specific differences and generates a unified and standardized set of questions and configuration data elements. In one embodiment, the COT system allows a user to provide input to manually define single standardized names, default values, and mappings for each of the coverage provider and state-specific data elements. Additionally or alternatively, the COT system provides user-configurable rules that are used to define a mapping logic used during the data field standardization process. The COT system publishes a unified, standardized coverage rating configuration data set via an API to other software applications. Additionally, the system tracks rating configuration data sets via a versioning mechanism such that specific configuration data set are stored, retrieved, copied, and/or reused as explicit configuration versions. Still further, the system allows the automated comparison of stored rating configuration versions via a graphical view (e.g., displayed in an application on the user client device 115) that highlights changes between versions and permits a user to update data field configuration values.

In one embodiment, the data communications module 215 provides direct API access to the connectivity hub server 105 to a coverage provider processor 125 to allow the coverage provider to control and customize a user interface of the connectivity hub server 105. Additionally, in some embodiments in which a user's existing coverage is updated, the data communications module 215 receives updated user information from the third-party data sources 135 and sends the received user data to the coverage processing module 220, as discussed below. In one example, the data communications module 215 queries one or more public records databases to request information about qualifying update events associated with the user, such as life events (e.g., marriage certificates, divorce certificates, birth certificates, etc.), information about the purchase, sale, renovation, or construction associated with real property (e.g., building permits, variances, special exemption permits, property transfer records, tax liens, changes to a property's square footage, etc.), information about the purchase or other acquisition of personal property valued at over a specified amount (e.g., a boat or a snowmobile), and/or information about a business entity associated with the user (e.g., registration information for a sole proprietorship, LLC, corporation, or partnership established by the user, a trademark application filed by the user, etc.). In one embodiment, the third-party data sources 135 include LexisNexis's Active Insight product, which provides to the data communications module 215 data about an existing user of the connectivity hub server 105 listing a property for sale. Other embodiments use other commercially available third-party data sources 135 instead of or in addition to the Active Insight product based on the specific application of the networked computing environment 100. “The data communications module 215 then sends the received data to the rules engine 235, which signals a variety of life events identified and returns coverage recommendations pre-bundled for qualified life events from the coverage processing module 220, as described below, to the front-end module 205 for the user to confirm the occurrence of the events or to update coverage.

In embodiments in which the user is seeking to bind coverage, the coverage processing module 220 aggregates user data received from the third-party data sources 135 and prefills one or more fields of an application for coverage using at least the user data received through the user client device 115 and the additional user data. In some embodiments, the coverage processing module 220 provides the additional user data for display on the user client device 115 to allow the user to verify the accuracy of the received data. The prefilled application is similarly provided to the user for approval before the coverage processing module 220 submits the completed application to the one or more coverage provider processors 125. Additionally, if the coverage processing module 220 determines that the user data received from the third-party data sources 135 does not include data responsive to one or more fields of the application, the coverage processing module 220 queries the user to provide the missing data. The user is further queried, in some embodiments, to answer one or more provider-specific questions based on the product line for which the user seeks coverage (e.g., auto, home, umbrella, etc.). Additionally, in some embodiments, the coverage processing module 220 allows the user to opt-in to an adaptive coverage policy as described herein.

In some embodiments, the coverage processing module 220 sets one or more terms of the application to a default amount, such as a default limit of liability (e.g., 100,000/300,000/500,000) and/or the choice of full coverage (e.g., comprehensive and collision coverage with a $500 deductible) such that the user client device 115 and/or the dealer terminal 120 display interface elements informing the user and/or the dealer user that the terms cannot be changed. The default terms are included in the application during the initial quoting process and may, in some implementations, be reviewed and adjusted during subsequent interactions between the user and the selected coverage provider. After the user selects an available coverage provider, the coverage processing module 220 facilitates the processing of the associated coverage option by generating documents such as applications, disclosures, identification cards, binders, and the like, and processing user payment by displaying and accepting user credit card and bank account information.

Additionally, in embodiments in which a user's existing coverage is updated, the coverage processing module 220 receives and analyzes the updated user information from the data communications module 215. In one embodiment, the coverage processing module 220 maintains a list of qualifying update events and compares the received user information to the list of qualifying update events to determine whether an event has occurred. For example, if the information indicates that the user is married, the coverage processing module 220 determines that the user is likely to possess one or more items of personal property valued at over a specified amount that are not covered in the user's existing coverage policy. In another example, the coverage processing module 220 determines that the user has obtained a building or zoning permit associated with a piece of real property and thus likely intends to add a new structure (e.g., a fence, an attached garage, and the like) to the property. Responsive to detecting the occurrence of a qualifying update event based on the received user information, the coverage processing module 220 notifies the coverage management module 225 to prompt one or more coverage updates.

In other embodiments, detection of a qualifying update event is based on user input. In this implementation, the user provides input through the user client device 115 to notify the connectivity hub server 105 of the user's purchase of the engagement ring or the building permit. The front-end module 205 notifies the coverage processing module 220 of the user input, and the coverage processing module 220 sends the notification to the coverage management module 225 to determine one or more proposed coverage updates.

In still other embodiments, detection of a qualifying update event is based on the connectivity hub server 105 determining that one or more members of the user's family have reached a specified age. For example, if the connectivity hub server 105 determines that the user's son turned 15, front-end module 205 might query the user to determine whether the user wants to add their son to an existing auto policy. Similarly, if it is determined that the user's daughter turned 17 or 18, the front-end module 205 might ask the user whether they want to add to the existing coverage an endorsement covering the user's property off-premises.

In embodiments in which the user is seeking to bind coverage, the coverage management module 225 queries each of a plurality of coverage provider processors 125 for available coverage options based on the generated application. In one embodiment, the data communications module 215 requests, from each coverage provider processor 125, a “rate call 1” rate, such that the rate is non-binding and is based on data provided by the user (i.e., the accuracy of the user-provided data is not verified by data from one or more third-party data sources 135). As discussed below, in some embodiments, the coverage management module 225 queries a subset of the coverage provider processors 125 for updated coverage options (i.e., “rate call 2” rates) responsive to receiving additional data about the user from one or more third-party data sources 135. In another embodiment, the coverage management module 225 sends the completed application to the comparative rater platform 140, which returns one or more initial coverage options and rates based on the user data and stored coverage data for the coverage provider processors 125.

In some embodiments, the coverage management module 225 optimizes profitability via machine learning by using a trained model to determine which of the received coverage options to provide for display to the user. In various implementations, input to the trained model includes user data such as household composition, driver class, driving history, insurance status and history, and data associated with the vehicle that the user is purchasing. Input to the model further includes profitability data indicating the user's likely retention rate, a commission rate, and the like. For example, if stored profile data for user A indicates that the user is likely to stay with a coverage provider for a long period of time, the model outputs an instruction to display to the user only available coverage providers that have a higher lifetime expectancy.

In embodiments where additional user data is provided to a dealer terminal 120 used by a dealer user (e.g., an employee of a dealership at which the user is purchasing a vehicle), the coverage management module 225 obscures some or all of the received from the third-party data sources 135 on the display of the dealer terminal 120. In some implementations, the coverage management module 225 analyzes the received user data and determines whether one or more data items have at least a threshold level of sensitivity (e.g., the data includes the user's credit card number, income information, PII, or the like). Responsive to determining that the sensitivity level for one or more data items exceeds the threshold, the coverage management module 225 obscures the data items such that the dealer user is not able to see the sensitive user data. Rather, the coverage management module 225 provides for display on the dealer terminal 120 an indication that the data collection has been completed. Additionally, in embodiments in which the user is seeking to bind coverage (e.g., auto insurance coverage), the coverage management module 225 queries the rules engine 235 to generate quotes for one or more additional coverage options based on user data obtained from the coverage application and from one or more third-party data sources 135, as discussed below.

In embodiments in which the coverage management module 225 receives a notification of a qualifying update event from the coverage processing module 220, the coverage management module 225 queries a stored mapping to determine one or more proposed coverage updates to propose to the user. For each qualifying update event, the mapping includes one or more proposed updates to a user's existing policy that add, remove, or change coverage. For instance, with respect to the examples discussed above, the mapping might indicate that the purchase of a boat is associated with a proposal (e.g., via endorsement or rider) to add boat insurance (e.g., including one or more of liability, uninsured motorist, and collision/comprehensive coverage) or that the building permit is associated with a proposal to add outbuilding coverage and/or increase existing personal liability coverage (e.g., adding a fenced pool in the backyard).

In some embodiments, each qualifying update event is associated with a pre-defined endorsement bundle with suggested coverage updates. For example, if it is determined that the user is renting out a portion of their residence for home sharing or business purposes, the coverage management module 225 recommends a set of coverage related to the situation (e.g., extending existing homeowners coverage to a short-term rental, adding an endorsement to cover a temporary rental, or adding landlord or business insurance). In another example, if the user's child moves into a dorm or apartment, the coverage management module 225 recommends a different endorsement bundle (e.g., adding coverage for the user's vehicles or other personal property off-premises).

Responsive to determining one or more proposed coverage updates based on the qualifying update event(s), the coverage management module 225 instructs the front-end module 205 to query the user (e.g., through the user client device 115) to confirm the occurrence of the event and to provide for display the proposed coverage update. For example, the front-end module 205 might provide a message querying the user “Did you purchase an RV?” If the user confirms the purchase, the front-end module 205 might provide a secondary message stating “Would you like to speak with someone about adding RV coverage?” Similarly, if the qualifying update event is the user obtaining the building permit, the front-end module 205 might provide a message querying the user “Did you recently obtain a building permit for 123 Main Street?” If the user answers in the affirmative, the front-end module 205 might provide a secondary message stating “Would you like to speak with someone about adding outbuilding coverage to your property?” If the user confirms an intent to update the user's existing coverage, the front-end module 205 notifies the coverage management module 225 of the update instruction. Responsive to receiving the notification, the coverage management module 225 updates the existing coverage for the user in accordance with the user input (i.e., by updating a user profile in the user data store 245).

Additionally, in some embodiments, the front-end module 205 notifies the coverage communications module 230 of the user input, as discussed below. The coverage communications module 230 facilitates communication between the user and a selected coverage provider by establishing a direct communication channel between the user client device 115 and the coverage provider agent device 130A associated with the selected coverage provider processor 125A. In one embodiment, the user selects a preferred method of communication with the selected coverage provider, such as instant messaging, video call, or telephone call. The coverage provider may prompt the user to answer additional questions or provide additional information in accordance with the provider's policies or requirements. Additionally, in some embodiments, the coverage communications module 230 provides for display on the coverage provider agent device 130A an interface allowing the coverage provider to access the user's completed application and/or additional data associated with the user and stored in the user data store 245, such as motor vehicle records and accident and claim history reports.

In one embodiment, the direct connection generated by the coverage communications module 230 allows the user and the coverage provider to communicate about available coverage options and select a policy that fits the user's needs. The coverage provider provides a bindable quote to the user and sends to the user policy documentation associated with the selected coverage option. For example, in one embodiment, the coverage provider processor 125A sends the policy documentation directly to the user client device 115 (e.g., via email). In other embodiments, the policy documentation is uploaded to the connectivity hub server 105 such that the user client device 115 can access the documentation through the front-end module 205. In some implementations, the policy documentation includes one or more documents for execution by the user. The user accesses the documents, for example, by using a hyperlink provided by the coverage provider processor 125A and executes the documents using DocuSign or another means of electronic signature.

Additionally, in embodiments in which the user seeks to update existing coverage, as discussed above, the direct connection generated by the coverage communications module 230 allows the user to communicate with the coverage provider associated with the user's current policy to discuss the qualifying update event and to execute policy documentation associated with the one or more proposed coverage updates without terminating the existing policy.

In embodiments in which the user seeks to bind coverage, the rules engine 235 analyzes user data to determine whether the user qualifies for policy price-matching. In one embodiment, the rules engine 235 queries the user for the user's account information (e.g., ID and password) associated with a first type of coverage (e.g., homeowner's insurance coverage). The rules engine 235 uses the received account information to query one or more third-party data sources 135 (e.g., mortgage escrow companies, title companies, government agencies, provider databases, etc.) for information about the user's current coverage such as the current policy provider, term, term limits, premium, insurance dwelling or property, coverage, limits, and deductibles. If the third-party data sources 135 do not return all of the requested user data, the rules engine 235 queries the user through the user client device 115 to provide the requested data. For example, if the user uploads a copy of a policy declaration through the front-end module 205, the rules engine 235 uses optical character recognition (OCR) on an image of the declaration page and analyzes the result of the OCR to determine the applicable coverage, limits, and deductibles.

Expense ratios, profit margins, rating factors, risk algorithms, and related data of available providers are aggregated and stored in a provider data store 250 on the connectivity hub server 105. Responsive to receiving the current coverage information for the user, the rules engine 235 uses data retrieved from the provider data store 250 and the current coverage information to calculate a predicted loss cost for the user under the user's current policy. In one embodiment, the rules engine 235 adds the allocated expense load and profit margin to determine the desired price and compares the desired price and the pre-determined price to determine if the specific risk is acceptable (i.e., if the user qualifies for price-matching). Alternatively, the rules engine 235 calculates the allowable gross profit margin and compares the desired gross profit margin and the allowable gross profit margin to determine if the specific risk is acceptable.

If the rules engine 235 determines that the user qualifies for price-matching, the front-end module 205 provides for display information about the proposed coverage package and individual policy price and savings based on the price-match offer. Conversely, if the rules engine 235 determines that the user does not qualify, the rules engine 235 identifies gaps in the user's current coverage and alerts the user, through the front-end module 205 to a possible exposure or coverage overage and prompts the user to speak with an agent.

In some embodiments, the rules engine 235 performs an image-mining algorithm to one or more photos submitted by the user through the user client device 115 to determine whether to suggest additional or updated coverage for one or more items of personal or real property depicted in the photo(s). If the output of the algorithm indicates that the risk is as described in the application and is under insurable conditions, the rules engine 235 approves the display of the recommended coverage updates to the user.

Still further, the rules engine 235 uses user data obtained from the completed coverage application and/or from one or more third-party data sources 135 to generate a quote for one or more types of additional coverage for the user. For example, user data used to complete the coverage application to bind auto insurance is supplemented, in one embodiment, by additional user data obtained from a financial institution or mortgage company to generate a homeowners' insurance quote for the user. In this way, the rules engine 235 is able to generate an additional coverage quote for the user with no or few additional questions required for manual input from either the user or the dealer. The user may then provide input to complete the binding process (e.g., by making payment or signing policy documents) on the user client device 115.

The rating engine 240 uses user data obtained from the completed coverage application and/or one or more third-party data sources 135 to generate an estimated premium for one or more types of additional coverage (e.g., homeowner's or renter's coverage). Commercial software is available for providing ratings for standalone purposes and, in one embodiment, is integrated into the connectivity hub server 105 to provide coverage premium(s). For example, in some embodiments, one or more of the PL Rating product of Vertafore, the DRC Rater of the Decision Research Corporation (DRC), and the CD Rating product of ClarionDoor are used to implement the rating engine 240. In this situation, the connectivity hub server 105 queries the coverage provider processor 125 directly and generates coverage options and premiums. Along with those obtained from the comparative rater platform 140, the connectivity hub server 105 sends all coverage options and premiums to the user client device 115 or to the dealer terminal 120 for the user to compare.

Each user of the connectivity hub server 105 is associated with a user profile, which is stored in the user data store 245. A user profile includes declarative information about the user that was explicitly shared by the user and also includes additional user information received from the third-party data sources 135 and one or more coverage provider processors 125. In one embodiment, a user profile includes multiple data fields, each describing one or more attributes of the corresponding user. Examples of data stored in a user profile include biographic information, employment and income information, credit information, payment information, current and past residences, household information, contact information, mobile device carrier, and current and past insurance policies and individuals and property covered by the policies. In certain embodiments, the user profile further includes policy documentation, such as completed applications and executed policy documents, as well as records of user consent to allow the modules of the connectivity hub server 105 to access and use the user data in the coverage selection and updating process. Stored data about a user is used, in some embodiments, to prefill applications or other documents such that the user does not have to provide data previously submitted to the connectivity hub server 105 and to update a user's existing coverage based on the occurrence of one or more qualifying update events. In such embodiments, the user instead is prompted, through the front-end module 205, to validate or update the stored information.

### Example Coverage Adaptation Process

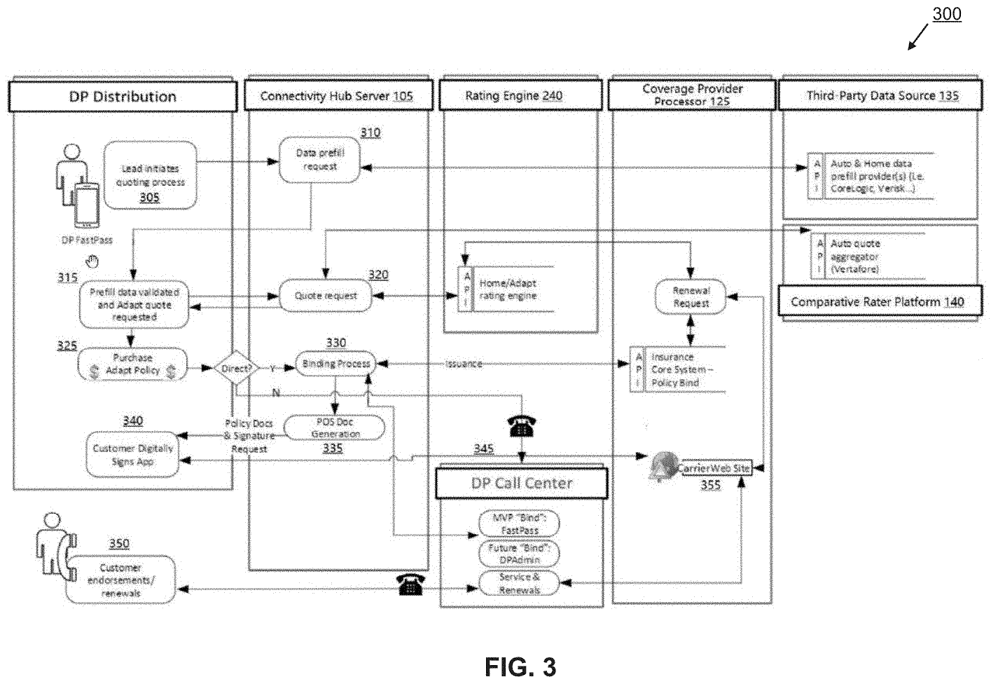

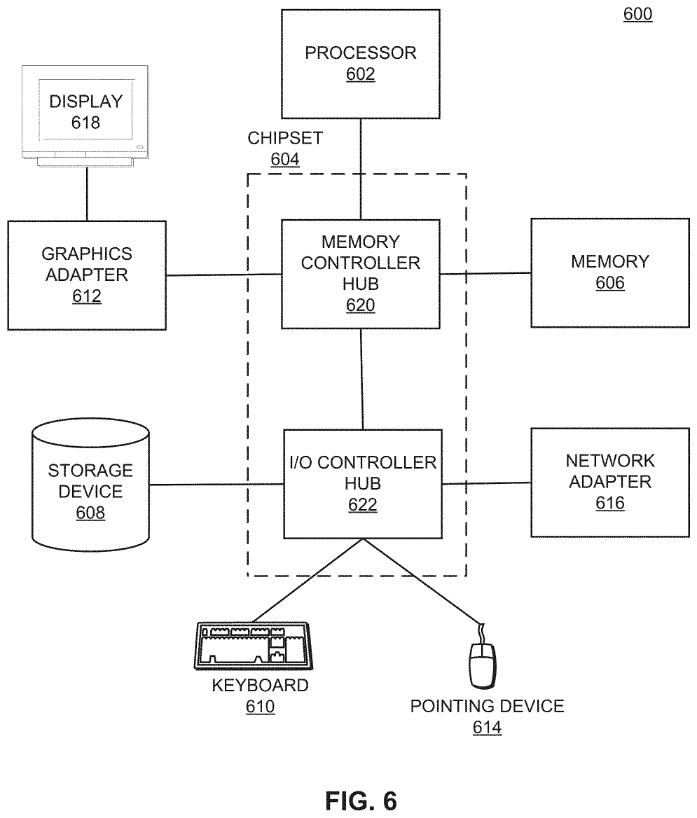

FIG. 3 is a data flow illustrating a method for binding an adaptive coverage policy, according to an embodiment. The steps of FIG. 3 are illustrated from the perspective of the connectivity hub server 105 that performs the method 300. However, in various implementations, some or all of the steps are performed by other entities or components. In addition, some embodiments perform the steps in parallel, perform the steps in different orders, or perform different steps. In addition, the steps are embodied as instructions executable by a processor of a machine, for example, as described by FIG. 6.

At 305, the user initiates the coverage binding process through the user client device 115 or the dealer terminal 120 by sending a request for coverage to the connectivity hub server 105. In one embodiment, the coverage request is a request to bind auto insurance coverage and includes user data including a user name, phone number, and information about the vehicle, such as the year, make, model, VIN, stock number, or the like. In some embodiments, responsive to receiving the user phone number, the front-end module 205 queries the user client device 115 requesting consent to access, use, and store user PII as part of the quotation and binding process.

In some embodiments, user PII is further used to verify the user's identity. For example, the front-end module 205 receives input from the user client device 115 of minimal PII, such as the user's zip code of primary residence and date of birth. The received PII is transmitted to the identity verification module 210, which verifies the user's identity by matching the received PII to the device from which the PII was sent. For example, the identity verification module 210 combines the received PII with one or more unique network interview device address or identification number(s) (e.g., SIM card, EMIEA number, etc.) assigned to the device to locate a subscriber record in a consumer information database connected to the connectivity hub server 105 and appends the subscriber record data to the received PII.

At 310, data communications module 215 queries one or more third-party data sources 135 containing PII and additional user information to append a plurality of additional PII, demographic, and other subscriber/prospective retail user information required for or pertinent to the user transaction (e.g., the purchase of a vehicle) and/or the user request for coverage. Additionally, in some embodiments, the additional user information includes information used to generate a homeowners or renters insurance quote for the user, including information from a financial institution, mortgage provider, data analytics and risk assessment entity, or credit bureau. Responsive to receiving the additional user information, the coverage processing module 220 aggregates the received data and prefills 315 one or more fields of a coverage application associated with the requested coverage. In one embodiment, the prefilled application is transmitted to the user client device 115, and, optionally, the dealer terminal 120, to allow the user and dealer to review, edit, and/or complete the prefilled application prior to submission to one or more coverage provider processors 125. Additionally, in embodiments in which the prefilled application is sent to a dealer terminal 120, some or all of the additional user information from the third-party data sources 135 is obscured on the dealer terminal 120. For example, as discussed above with respect to FIG. 2, the coverage management module 225 analyzes the received user data to determine whether one or more data items have at least a threshold level of sensitivity (e.g., the data includes the user's credit card number or income information). Responsive to determining that the sensitivity level for one or more data items exceeds a threshold, the coverage management module 225 obscures the data item(s) on the dealer terminal 120 such that the dealer is not able to see the sensitive user data. The sensitive data, however, is provided for display on the user client device 115 to allow the user to view and, in some embodiments, edit the information. In one embodiment, the completed application includes a request for an adaptive coverage policy in which coverage updates are implemented based on the occurrence of qualifying update events, as discussed herein.

The coverage processing module 220 receives the completed application and transmits 320 the application to the comparative rater platform 140 and one or more coverage provider processors 125 backed by the rating engine 240 with a request for coverage options and rates. While FIG. 3 includes one rating provider system (i.e., rating engine 240) and one quote, in other embodiments, the coverage binding process is iterative when qualifying events are identified and includes multiple coverage provider processors 125 that provide initial and updated quotes (e.g., “rate call 1” and “rate call 2” quotes) based on user input and, in some instances, additional user data received from the third-party data sources 135.

The coverage provider processor 125 sends a coverage option and quote to the data communications module 215, which provides the information for display to the user through the front-end module 205. Responsive to receiving user input indicating an intent to purchase 325 the coverage option using a direct bind process 330, the coverage processing module 220 performs API-based purchase and payment processing with one or more third-party data sources 140, such as a lending platform, an insurance rating platform, a carrier platform, a payment platform, and a document platform. The coverage processing module 220 further generates and provides 335 policy documents associated with the selected coverage option. In one embodiment, the policy documents are sent by the coverage communications module 230 to the user client device 115 for execution 340 and executed policy documents are stored in the user profile in the user data store 245.

Alternatively, if the user input indicates that the user does not wish to use the direct bind process, the coverage communications module 230 initiates a direct communication 345 with the user, for example through a phone call, video chat, or other communication between the user client device 115 and a human agent associated with the connectivity hub server 105 to allow the user to bind coverage. In some embodiments, the user interacts 350 with a human agent associated with the connectivity hub server 105 to obtain or update endorsements or renewals for existing coverage and the human agent interacts 355 with a website associated with the user's coverage provider 125 to complete the endorsement or renewal process.

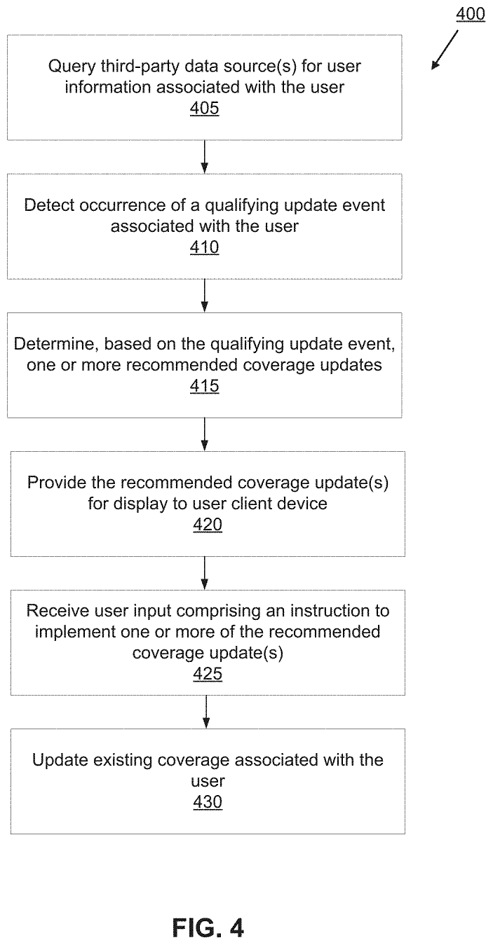

The method 300 is an iterative process and some or are of the steps described above are repeated if the modules of the connectivity hub server 105 determine that one or more qualifying update events has occurred. In some embodiments, the front-end module 205 prompts the user, during or after the initial coverage binding process, to install an application associated with the connectivity hub server 105 on the user client device 115. In this way, the user may interact with the connectivity hub server 105 to update existing coverage based on the update event(s), as discussed above with respect to FIG. 2 and below with respect to FIG. 4. Additionally, in some embodiments, the connectivity hub server 105 provides, through the application, information about additional products for the user, including quotes for home, auto, boat, RV, and other types of coverage in the form of advertisements or promotions through notifications, emails, text, and the like.

### Example Data Flow

FIG. 4 is a flow chart illustrating a method for implementing an adaptive coverage policy, according to an embodiment. The steps of FIG. 4 are illustrated from the perspective of the connectivity hub server 105 that performs the method 400. However, in various implementations, some or all of the steps are performed by other entities or components. In addition, some embodiments perform the steps in parallel, perform the steps in different orders, or perform different steps. In addition, the steps are embodied as instructions executable by a processor of a machine, for example, as described by FIG. 6.

For a user for whom the connectivity hub server 105 has bound an adaptive coverage policy (e.g., using the method 300 described in FIG. 3), the connectivity hub server 105 generates recommended coverage updates based on the occurrence of a qualifying update event. At 405, the data communications module 215 queries one or more third-party data sources 135 for information associated with the user. For example, in one embodiment, the third-party data sources 135 are public records databases. Additionally or alternatively, the third-party data sources 135 include entities with which the user has a preexisting relationship or is otherwise associated and to whom the user has provided consent to share user data with the connectivity hub server 105. For example, third-party data sources 135 with which the user is associated include one or more of financial institutions, mortgage providers, data analytics and risk assessment entities, credit bureaus, and the like.

The method 400 is iterative and may be performed periodically as the user's coverage requirements change over time (e.g., as the user gets married, buys a home, has children, moves, retires, etc.). For example, in one embodiment, the data communications module 215 queries the third-party data sources 135 periodically and/or receives periodic updates about qualifying update events from the user through the user client device 115.

Responsive to receiving user information from the one or more third-party data sources 135 and/or update information from a user through the user client device 115, the data communications module 215 sends the information to the coverage processing module 220, which detects 410 the occurrence of a qualifying update event associated with the user. In one embodiment, the coverage processing module 220 compares the received information to a list of qualifying update events to determine whether an event has occurred. For example, if the information indicates that the user has received approval for a loan to purchase a snowmobile, the coverage processing module 220 determines that the user has likely purchased or intends to purchase the snowmobile. In other embodiments, detecting the occurrence of the qualifying update event is based on user input (e.g., based on the user notifying the connectivity hub server that the user intends to purchase, or has already purchased, the snowmobile).

The coverage processing module 220 notifies the coverage management module 225 of the occurrence of the update event. In one embodiment, the coverage management module 225 determines 415 one or more recommended coverage updates based on the event by querying a stored mapping. For each qualifying event, the mapping includes one or more proposed updates to the user's existing policy that add, remove, or change coverage. For instance, with respect to the example discussed above, the mapping might indicate that the purchase of a snowmobile is associated with a proposal (e.g., via endorsement or a separate policy) to add snowmobile coverage (e.g., including one or more of liability, uninsured motorist, and collision/comprehensive coverage). In various embodiments, the recommended updates include a single proposed update to existing coverage or a pre-defined bundle with suggested coverage updates, as discussed above with respect to FIG. 2.

The front-end module 205 provides 420 the recommended coverage updates for display to the user through the user client device 115. In one embodiment, the front-end module 205 queries the user to confirm the occurrence of the event and provides the recommended coverage updates responsive to the user input confirming the event occurrence. For instance, continuing the above example, the front-end module 205 queries the user “Did you recently purchase a snowmobile?” If the user confirms the purchase or an intent to purchase, the front-end module 205 sends a follow-up query asking the user whether they want to supplement their existing coverage by adding an endorsement or a policy to cover the snowmobile. Additionally or alternatively, the query includes a suggestion that the user discuss available coverage updates with a representative associated with the connectivity hub server 105 and/or a coverage provider.

At 425, the front-end module 205 receives user input comprising an instruction to implement one or more of the recommended coverage updates. For example, the user might wish to supplement their existing coverage with liability, but might choose not to add uninsured motorist or collision/comprehensive coverage for the snowmobile (e.g., because it is of seasonal use only).

Responsive to receiving the user input, the coverage management module 225 updates 430 the existing coverage associated with the user in accordance with the user input. For example, in one embodiment the coverage management module 225 updates a user profile in the user data store 245 to reflect the change in coverage (e.g., to indicate that the user's current coverage now includes one or more coverage options from predefined snowmobile coverage bundles for different usage).

### Example Machine Learning Subsystem

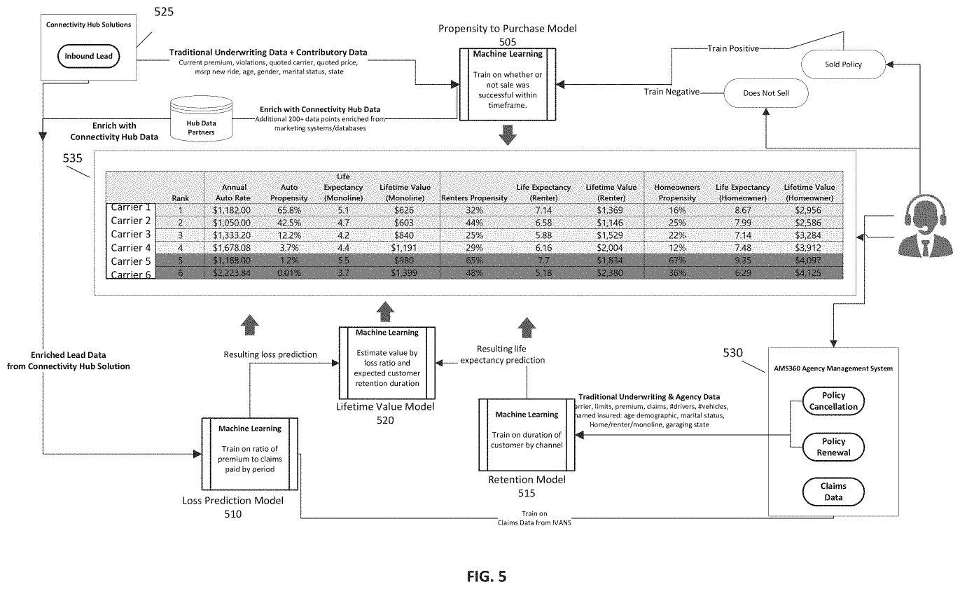

FIG. 5 is a subsystem diagram illustrating components of the connectivity hub server 105 and interactions between the components, according to one embodiment. The embodiment displayed in FIG. 5 includes a propensity to purchase model 505, a loss prediction model 510, a retention model 515, a lifetime value model 520, a connectivity hub 525, an agency management system 530, and a user coverage table 535.

In some implementations, the connectivity hub server 105 uses the models to predict coverage data for an incoming user, such as the user's propensity to purchase one or more types of coverage, a loss prediction for the user, the user's expected retention duration, and a lifetime value of the user. For example, the connectivity hub 525 receives, through a user client device 115 or a dealer terminal 120, data associated with a new user seeking coverage from a coverage provider. The connectivity hub 525 provides as input to the propensity to purchase model 505 underwriting and contributory data associated with the user, such as the user's current premium, violations, quoted carrier, quoted price, a manufacturer's suggested retail price of a vehicle, as well as biographic information about the user, such as the user's age, gender, marital status, state of residence, and the like. In one embodiment, the connectivity hub server 105 queries one or more third-party data sources 135 for additional data about the user and enriches the user data with the additional data received from the third-party data sources 135 prior to inputting the data into the propensity to purchase model 505.

In one embodiment, the propensity to purchase model 505 is trained based on historical data associated with past coverage purchases. The connectivity hub server 105 receives from a dealer terminal 120 data indicating whether the dealer sold a coverage policy to a given user. If the dealer sold a coverage policy to the user, data indicating the sale and associated user information is included in a positive training set of data used to train the propensity to purchase model 505. Conversely, if the dealer did not sell a coverage policy to a user, data indicating the lack of a sale and associated user information is included in a negative training set of data used to train the propensity to purchase model 505. The propensity to purchase model 505 is thus trained on whether a sale to a given user was successful, and the trained model outputs, based on received user data, an indication of whether the user is likely to purchase coverage through the connectivity hub server 105. For each sold policy, the propensity to purchase model 505 is subsequently trained to predict the likelihood of cross-selling additional policies or increasing coverage needs through time (i.e. adapting).

The enriched user data discussed above additionally serves as input to the loss prediction model 510. In one embodiment, the connectivity hub server 105 uses machine learning to train the loss prediction model 510 based on training data received from the agency management system 530. The training data includes ratios of coverage policy premiums to claims paid by the coverage provider. Once trained, the loss prediction model 510 outputs, for a given user, an associated loss prediction if the user purchases coverage through the connectivity hub server 105.

The agency management system 530 further provides user data used to train the retention model 515. For example, in one embodiment, the training data includes coverage policy cancellation and renewal data, as well as underwriting and agency data for a user, such as an associated coverage provider, policy premium, claim data, the number of drivers and vehicles in the user's household, whether the user has homeowner's insurance, renter's insurance, and/or monoline insurance, a garaging state of a user vehicle, and demographic data associated with the user, such as the user's age and marital status. The connectivity hub server 105 uses machine learning to train the retention model 515 on the duration of users' relationships with coverage providers and outputs, for a given user, a resulting prediction of the life expectancy of the relationship with the coverage provider from whom the user purchases coverage.

The connectivity hub server 105 inputs the loss prediction generated by the loss prediction model 510 and the life expectancy prediction generated by the retention model 515 to the lifetime value model 520, which computes an estimated lifetime value of a given user. In one embodiment, the lifetime value model 520 estimates the user value based on a loss ratio and an expected user retention duration.

The connectivity hub server 105 further maintains, for each user, a user coverage table 535 that includes, for each of a plurality of coverage providers and types of coverage (e.g., auto insurance, renter's insurance, homeowner's insurance, and the like), the values calculated by the propensity to purchase model 505, the loss prediction model 510, the retention model 515, and the lifetime value model 520. In some embodiments, the values generated by the models are used to rank the carriers and to determine which coverage providers and associated coverage options to display to the user. The connectivity hub server 105 further stores the user coverage table 535 in a user profile in the user data store 245.

### Computing System Architecture

FIG. 6 is a block diagram illustrating physical components of a computer 600 used as part or all of the connectivity hub server 105, in accordance with an embodiment. Illustrated are at least one processor 602 coupled to a chipset 604. Also coupled to the chipset 604 are a memory 606, a storage device 608, a graphics adapter 612, and a network adapter 616. A display 618 is coupled to the graphics adapter 612. In one embodiment, the functionality of the chipset 604 is provided by a memory controller hub 620 and an I/O controller hub 622. In another embodiment, the memory 606 is coupled directly to the processor 602 instead of the chipset 604.

The storage device 608 is any non-transitory computer-readable storage medium, such as a hard drive, compact disk read-only memory (CD-ROM), DVD, or a solid-state memory device. The memory 606 holds instructions and data used by the processor 602. The graphics adapter 612 displays images and other information on the display 618. The network adapter 616 couples the computer 600 to a local or wide area network.

As is known in the art, a computer 600 can have different and/or other components than those shown in FIG. 6. In addition, the computer 600 can lack certain illustrated components. In one embodiment, a computer 600, such as a host or smartphone, lacks a graphics adapter 612, and/or display 618, as well as a keyboard 610 or external pointing device 614. Moreover, the storage device 608 can be local and/or remote from the computer 600 (such as embodied within a storage area network (SAN)).

As is known in the art, the computer 600 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 608, loaded into the memory 606, and executed by the processor 602.

### Additional Considerations

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments are described using the expression “coupled” and “connected” along with their derivatives. It should be understood that these terms are not intended as synonyms for each other. For example, some embodiments are described using the term “connected” to indicate that two or more elements are in direct physical or electrical contact with each other. In another example, some embodiments are described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but , in some embodiments, also includes other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for providing a connectivity hub having data-hiding features. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed. The scope of protection should be limited only by the following claims.

1. A connectivity hub system comprising:
a user processor associated with a user of the connectivity hub system;
a plurality of third-party data processors storing user information associated with the user; and
a connectivity hub server comprising:
a data communications module configured to query the plurality of third-party data processors for user information associated with the user;
a coverage processing module configured to analyze the additional information received from the third-party data processors to determine the occurrence of a qualifying update event associated with the user;
a coverage management module configured to determine, based on the qualifying update event, one or more recommended coverage updates to existing coverage associated with the user; and
a front-end module configured to provide the recommended coverage updates for display to the user processor and receive user input comprising an instruction to implement one or more of the recommended coverage updates.

2. The connectivity hub system of claim 1, wherein the front-end module is further configured to query the user through the user processor to confirm the occurrence of the qualifying update event.

3. The connectivity hub system of claim 1, wherein determining the one or more recommended coverage updates comprises querying a stored mapping between qualifying update events and recommended coverage updates.

4. The connectivity hub system of claim 1, wherein the existing coverage associated with the user comprises a first type of coverage, and wherein the one or more recommended coverage updates include a recommendation to add at least a second type of coverage.

5. The connectivity hub system of claim 1, further comprising a coverage communications module configured to notify a coverage provider processor associated with the existing coverage of the instruction to implement the one or more of the recommended coverage updates.

6. The connectivity hub system of claim 1, further comprising a rules engine configured to:
receive, from the user processor, one or more photos of an item of personal or real property associated with the qualifying update event; and
apply a risk algorithm to determine whether to provide one or more recommended coverage updates to the existing coverage.

7. The connectivity hub system of claim 1, wherein detecting the occurrence of the qualifying update event is based at least in part on user input through the user processor.

8. A computer-implemented method for implementing, by a connectivity hub server, an adaptive coverage policy, the method comprising:
querying one or more third-party data sources for user information associated with a user of the connectivity hub server;
detecting, based at least in part on received user information from the one or more third-party data sources, occurrence of a qualifying update event associated with the user;
determining, based on the qualifying update event, one or more recommended coverage updates to existing coverage associated with the user;
providing the recommended coverage updates for display to the user through a user device; and
responsive to receiving user input comprising an instruction to implement one or more of the recommended coverage updates, updating the existing coverage associated with the user.

9. The computer-implemented method of claim 8, further comprising querying the user through the user device to confirm the occurrence of the qualifying update event.

10. The computer-implemented method of claim 8, further comprising querying a stored mapping between qualifying update events and recommended coverage updates to determine the one or more recommended coverage updates to the existing coverage associated with the user.

11. The computer-implemented method of claim 8, wherein the existing coverage associated with the user comprises a first type of coverage, and wherein the one or more recommended coverage updates include a recommendation to add at least a second type of coverage.

12. The computer-implemented method of claim 8, further comprising notifying a coverage provider processor associated with the existing coverage of the instruction to implement the one or more of the recommended coverage updates.

13. The computer-implemented method of claim 8, wherein, in response to detecting the occurrence of the qualifying update event, the method further comprises:
instructing the user to provide one or more photos of an item of personal or real property associated with the qualifying update event; and
responsive to receiving the one or more photos, applying, by a rules engine, a risk algorithm to determine whether to provide one or more recommended coverage updates to the existing coverage.

14. The computer-implemented method of claim 8, wherein detecting the occurrence of the qualifying update event is based at least in part on user input.

15. A non-transitory computer readable storage medium storing instructions that, when executed by a computing device, cause the computing device to execute steps comprising:
querying one or more third-party data sources for user information associated with a user of the connectivity hub server;
detecting, based at least in part on received user information from the one or more third-party data sources, occurrence of a qualifying update event associated with the user;
determining, based on the qualifying update event, one or more recommended coverage updates to existing coverage associated with the user;
providing the recommended coverage updates for display to the user through a user device; and
responsive to receiving user input comprising an instruction to implement one or more of the recommended coverage updates, updating the existing coverage associated with the user.

16. The non-transitory computer-readable storage medium of claim 15, wherein the steps further comprise querying the user through the user device to confirm the occurrence of the qualifying update event.

17. The non-transitory computer-readable storage medium of claim 15, wherein the steps further comprise querying a stored mapping between qualifying update events and recommended coverage updates to determine the one or more recommended coverage updates to the existing coverage associated with the user.

18. The non-transitory computer-readable storage medium of claim 15, wherein the existing coverage associated with the user comprises a first type of coverage, and wherein the one or more recommended coverage updates include a recommendation to add at least a second type of coverage.

19. The non-transitory computer-readable storage medium of claim 15, wherein the steps further comprise notifying a coverage provider processor of the instruction to implement the one or more of the recommended coverage updates.

20. The non-transitory computer-readable storage medium of claim 15, wherein, in response to detecting the occurrence of the qualifying update event, the steps further comprise:
instructing the user to provide one or more photos of an item of personal or real property associated with the qualifying update event; and
responsive to receiving the one or more photos, applying, by a rules engine, a risk algorithm to determine whether to provide one or more recommended coverage updates to the existing coverage.
